(19) United States
(12) Patent Application Publication
(10) Pub. No.: US 2022/0267487 A1
(43) Pub. Date: Aug. 25, 2022

(54) PROCESS FOR HIGH SULFER CONTENT COPOLYMER PREPARATION

(71) Applicant: ENI S.P.A., Roma (IT)

(72) Inventors: Giuseppe Bellussi, San Donato Milanese (IT); Alberto Renato De Angelis, San Donato Milanese (IT); Chiara Carrozza, Milano (IT); Laura Boggioni, Abbiategrasso (IT)

(73) Assignee: ENI S.P.A., Roma (IT)

(21) Appl. No.: 17/625,191

(22) PCT Filed: Jul. 7, 2020
(86) PCT No.: PCT/IB2020/056383

§ 371 Date: Jan. 6, 2022

(30) Foreign Application Priority Data
Jul. 8, 2019 (IT) 102019000011121

(51) Int. Cl. C08F 36/14; C08F 8/34; C08F 36/22; C08F 4/10

(52) U.S. Cl. CPC C08F 36/14; C08F 8/34; C08F 36/22; C08F 4/10

(57) ABSTRACT

There is a process for high sulfur content copolymer preparation having the step of reacting sulfur in solid form with at least one crosslinker selected from organic compounds having at least a double or triple bond in the presence of at least one catalyst selected from dithiocarbamates, mercaptobenzothiazoles, xanthates, thiophosphates, at a temperature ranging from 110° C. to 180° C.

The high sulfur content copolymer, depending on the glass transition temperature, can be of elastomeric or thermoplastic type and can be advantageously used in different applications. In case of an elastomeric-type high sulfur content copolymer, the copolymer can be advantageously used in different applications such as, for example, thermal insulation, conveyor belts, transmission belts, flexible tubes, elastomeric tire compositions. In case of a thermoplastic-type high sulfur content copolymer, the copolymer can be advantageously used, as such or in a mixture with other (co)polymers (for example, styrene, divinylbenzene), in different applications such as, for example, packaging, electronics, household appliances, computer cases, CD cases, kitchen, laboratories, offices and medical items, in building and construction.

### CROSS-REFERENCE TO RELATED APPLICATIONS

This patent application claims priority from PCT Application No. PCT/M2020/056383, filed Jul. 7, 2020, which claims priority from Italian Patent Application No. 102019000011121, filed on Jul. 8, 2019, the entire disclosures of both of which are incorporated herein by reference.

### FIELD OF THE DISCLOSURE

The disclosure relates to a process for high sulfur content copolymer preparation comprising reacting sulfur in solid form with at least one crosslinker selected from organic compounds containing at least a double or triple bond, in the presence of at least one catalyst selected from dithiocarbamates, mercaptobenzothiazoles, xanthates, thiophosphates.

### DESCRIPTION OF THE RELATED ART

It is known that in the oil industry during the production of natural gas and oil increasingly greater amounts of elemental sulfur are produced, the output surplus of which presently exceeds one million tons a year with a further increasing trend as new sectors develop wherein the content of sulfurized acid (H₂S) and elemental sulfur will be increasingly more relevant. The global sulfur output surplus does not only result into a drop of the market price thereof, whereby transport costs can adversely affect trading thereof, but it also causes relevant environmental problems due to storage of massive amounts of elemental sulfur. In fact, in case it is stored on the surface or underground, the action by atmospheric agents can cause contamination of the surrounding areas. In this regard, it can be mentioned, for instance, the phenomenon known as “dusting” or dispersion of sulfur dust which, in turn, can produce acid substances (for example, sulphuric acid) by oxidation.

Studies were carried out in order to use elemental sulfur for preparing high sulfur content copolymers.

For example, Patent Application US 2014/0199592 discloses a polymer composition comprising a sulfur copolymer, in a quantity of at least about 50% by weight with respect to the copolymer, and one or more monomers selected from the group consisting in ethylenically unsaturated monomers, epoxy monomers, thiirane monomers, in a quantity ranging from about 0.1% by weight to about 50% by weight with respect to the copolymer. The aforesaid high sulfur content polymer composition is said to be advantageously usable in electrochemical cells and optical elements.

Griebel J. J. et. al, in “Advanced Materials” (2014), Vol. 26, pages 3014-3018, disclose preparing thermoplastic high sulfur content copolymers obtained by means of the inverse vulcanization technique making sulfur and 1,3-diisopropenylbenzene (DIB) react. The aforesaid thermoplastic copolymers are said to have an excellent transparency in the IR spectrum and a high refractive index (n˜1.8). Furthermore, the aforesaid thermoplastic copolymers are said to be advantageously usable as optical materials transparent to infrared light.

Khaway S. Z. et al., in “Material Letters” (2017), Vol. 203, pages 58-61, disclose preparing flexible high sulfur content copolymers obtained by means of the inverse vulcanization technique making sulfur and diallyl disulfide react. The aforesaid copolymers are said to have a good transparency, a high flexibility due to their low glass transition temperature (T_{g}), a very low Young module and a high tensile strain at break. Furthermore, the aforesaid copolymers are said to be advantageously usable as thermal insulation or infrared light-transparent optical materials.

However, the processes described in the aforesaid documents can have some drawbacks. For example, the reactions described in the aforesaid documents occur merely thermally: as a matter of fact, as the temperature increases the orthorhombic (eight-sided ring) crystal-form sulfur (S₈) opens resulting in a low concentration of radicals which causes the polymerization reaction with crosslinkers. However, these reactions are limited in that only some crosslinkers are able, in the herein described conditions, to carry out a complete inverse vulcanization reaction while others carry out a partial inverse vulcanization reaction, or do not even react.

Since, as mentioned above, there is a sulfur global output surplus, using it for preparing high sulfur content copolymers, particularly using sulfur in new processes for preparing high sulfur content copolymers, is still of great interest.

### SUMMARY OF THE DISCLOSURE

The Applicant has thus faced the problem of finding a new process for preparing high sulfur content copolymers.

The Applicant has now surprisingly found out that it is possible, by means of the inverse vulcanization reaction in the presence of suitable catalysts, to use crosslinkers which, as above mentioned, carry out a partial inverse vulcanization reaction or do not even react.

In particular, the Applicant has now found out that using a catalyst selected from dithiocarbamates, mercaptobenzothiazoles, xanthates, thiophosphates, in a process of preparing high sulfur content copolymers, allows to obtain a complete polymerization, in a short time. Furthermore, using said catalyst allows to obtain high sulfur content copolymers having a different glass transition temperature (T_{g}) which can, therefore, be of both elastomeric and thermoplastic type. In case of an elastomeric-type high sulfur content copolymer, said copolymer can be advantageously used in different applications such as, for example, thermal insulation, conveyor belts, transmission belts, flexible tubes, elastomeric tire compositions. In case of a thermoplastic-type high sulfur content copolymer, said copolymer can be advantageously used, as such or in a mixture with other (co)polymers (for example, styrene, divinylbenzene), in different applications such as, for example, packaging, electronics, household appliances, computer cases, CD cases, kitchen, laboratories, offices and medical items, in building and construction.

The object of present disclosure is therefore a process for preparing high sulfur content copolymers comprising reacting sulfur in solid form with at least one crosslinker selected from organic compounds containing at least a double or triple bond, in the presence of at least one catalyst selected from dithiocarbamates, mercaptobenzothiazoles, xanthates, thiophosphates, at a temperature ranging from 110° C. to 180° C., preferably ranging from 120° C. to 150° C., for a time ranging from 20 minutes to 12 hours, preferably ranging from 30 minutes to 10 hours.

Said high sulfur content copolymer, depending on the glass transition temperature (T_{g}), can be of elastomeric or thermoplastic type and can be advantageously used in different applications. In case of an elastomeric-type high sulfur content copolymer, said copolymer can be advantageously used in different applications such as, for example, thermal insulation, conveyor belts, transmission belts, flexible tubes, elastomeric tire compositions. In case of a thermoplastic-type high sulfur content copolymer, said copolymer can be advantageously used, as such or in a mixture with other (co)polymers (for example, styrene, divinylbenzene), in different applications such as, for example, packaging, electronics, household appliances, computer cases, CD cases, kitchen, laboratories, offices and medical items, in building and construction.

### DETAILED DESCRIPTION OF THE DISCLOSURE

For the purpose of the present description and the following claims, the definitions of the numerical intervals always comprise the extreme values unless otherwise specified.

For the purpose of the present description and the following claims, the term “comprising” also includes the terms “which essentially consists of” or “which consists of”.

According to a preferred embodiment of the present disclosure, said sulfur in solid form is elemental sulfur.

For the purpose of the process object of the present disclosure, said elemental sulfur is preferably in powder form. At ambient conditions (i.e. at room temperature and pressure), elemental sulfur exists in orthorhombic (eight-sided ring) crystal form (S₈) and it has a melting temperature ranging from 120° C. to 124° C. Said elemental sulfur in orthorhombic crystal form (S₈), at a temperature higher than 159° C., is subjected to ring opening polymerization (ROP) and it is transformed into a polymeric linear chain with two free radicals at the ends. Said polymer linear chain is metastable and thus tends to be re-converted, more or less slowly depending on the conditions, into the orthorhombic crystal form (S₈).

For the purpose of the process object of the present disclosure, said elemental sulfur is in orthorhombic crystal form (S₈) being said form, generally, the stablest, most accessible and cheapest form. However, it must be noted that for the purpose of the present disclosure, the other allotropic forms of sulfur can also be used, such as, for example, the cyclic allotropic forms deriving from thermal processes which elemental sulfur in orthorhombic crystal form (S₈) can be submitted to. It must also be noted that any kind of sulfur able to obtain, when heated, species capable of being submitted to radical or anionic polymerization, can be used for the purpose of the process object of the present disclosure.

According to a preferred embodiment of the present disclosure, said crosslinker selected from organic compounds containing at least a double or triple bond can be selected, for example, from:
ethylenically unsaturated monomers which can be selected, for example, from linear aliphatic α-olefins such as, for example, 1,7-octadiene 1-dodecene, 5-methyl-1-heptene, 2,5-dimethyl-1,5-hexadiene, or mixtures thereof; alicyclic olefins and diolefins such as, for example, d-limonene, 1,4-dimethylenecyclohexane, 1-methylene-4-vinylcyclohexane, or mixtures thereof; conjugated polyenes such as, for example, 2-phenyl-1,3-butadiene, myrcene, allocymene, 1-vinylcyclohexene, ethylbenzofulvene, or mixtures thereof; bicyclic olefins such as, for example, α-pinene, β-pinene, 2-methylene-norbornene, or mixtures thereof; aromatic vinyl compounds such as, for example, styrene, divinyl benzene, vinyl toluene, tert-butyl styrene, p-methyl styrene, γ-methyl styrene, α-methyl styrene, vinyl naphthalene, 1,3-di-iso-propenylbenzene (DIB); or mixtures thereof;
alkynic monomers such as, for example, 1,3-diethynylbenzene (DEB), 2-ethynyl-1,3-dimethylbenzene, 1,3,5-triethynylbenzene; or mixtures thereof;
natural oils such as, for example, grapeseed oil, castor oil, soybean oil, linseed oil, sesame oil, or mixtures thereof;
   or mixtures thereof.

According to a particularly preferred embodiment of the present disclosure, said crosslinker selected from organic compounds containing at least a double or triple bond can be selected, for example, from: myrcene, 1,7-octadiene, grapeseed oil, 1,3-di-iso-propenylbenzene (DIB).

According to a preferred embodiment of the present disclosure, said dithiocarbamates can be selected, for example, from: zinc N-dimethyldithiocarbamate (ZnDMC), zinc N-diethyldithiocarbamate (ZnDEC), zinc N-dibutyldithiocarbamate (ZnDBC), zinc N-ethylphenyldithiocarbamate (ZnEPC), zinc N-pentamethylenedithiocarbamate (ZnCMC), zinc N-dibenzyl dithiocarbamate (ZnBEC), copper N-diethyldithiocarbamate (CuDEC), sodium N-diethyldithiocarbamate (NaDMC), cobalt N-diethyldithiocarbamate (CoDMC), or mixtures thereof; preferably zinc N-diethyldithiocarbamate (ZnDEC).

According to a preferred embodiment of the present disclosure, said mercaptobenzothiazoles can be selected, for example, from: 2-mercaptobenzothiazole (MBT), zinc salt of 2-mercaptobenzothiazole (ZnMBT), copper salt of 2-mercaptobenzothiazole (CuMBT), cobalt salt of 2-mercaptobenzothiazole (CoMBT), sodium salt of 2-mercaptobenzothiazole (NaMBT), or mixtures thereof; zinc salt of 2-mercaptobenzothiazole (ZnMBT) is preferred.

According to a preferred embodiment of the present disclosure, said xanthates can be selected, for example, from: zinc iso-propylxantate (ZnIX), zinc butylxantate (ZnBX), sodium iso-propylxantate (NaIX), copper iso-propylxantate (CuIX), cobalt iso-propylxantate (CoIX), or mixtures thereof; zinc iso-propylxantate (ZnIX) is preferred.

According to a preferred embodiment of the present disclosure, said thiophosphates can be selected, for example, from: zinc O,O-di-n-butyl dithiophosphate (ZBDP), zinc O-butyl-O-hexyl dithiophosphate, zinc O,O-di-iso-octyl dithiophosphate, cobalt O,O-di-n-butyl dithiophosphate (CoBDP), copper O,O-di-n-butyl dithiophosphate (CuBDP), or mixtures thereof; zinc O,O-di-n-butyl dithiophosphate (ZBDP) is preferred.

According to a preferred embodiment of the present disclosure, said catalyst can be used in a quantity ranging from 0.5% by weight to 10% by weight, preferably ranging from 0.8% by weight to 8% by weight, with respect to the total weight of sulfur in solid form and of said at least one crosslinker selected from organic compounds containing at least a double or triple bond.

Preferably, the high sulfur content copolymer obtained according to the process object of the present disclosure, comprises sulfur in a quantity higher than or equal to 35% by weight, preferably ranging from 40% by weight to 90% by weight, with respect to the total weight of said copolymer and at least one organic compound containing at least a double or triple bond in a quantity lower than or equal to 65% by weight, preferably ranging from 10% by weight to 60% by weight, with respect to the total weight of said copolymer.

As mentioned above, said high sulfur content copolymer, depending on the glass transition temperature (T_{g}), can be of elastomeric or thermoplastic type and can be advantageously used in different applications. In case of an elastomeric-type high sulfur content copolymer, said copolymer can be advantageously used in different applications such as, for example, thermal insulation, conveyor belts, transmission belts, flexible tubes, elastomeric tire compositions. In case of a thermoplastic-type high sulfur content copolymer, said copolymer can be advantageously used, as such or in a mixture with other (co)polymers (for example, styrene, divinylbenzene), in different applications such as, for example, packaging, electronics, household appliances, computer cases, CD cases, kitchen, laboratories, offices and medical items, in building and construction.

In order to better understand the present disclosure and to put it into practice, some illustrative and non-limiting examples thereof are reported below.

### BEST MODE FOR CARRYING OUT THE DISCLOSURE

### Examples

### Analysis and Characterization Methods

The below reported analysis and characterization methods were used.

Thermal Analysis (DSC)

For the purpose of determining the glass transition temperature (T_{g}) of the obtained copolymers, DSC (Differential Scanning calorimetry) thermal analysis was carried out by means of a Perkin Elmer Pyris differential scanning calorimetry, using the following thermal programme:

cooling from room temperature (T=25° C.) to −60° C. at a rate of −5° C./min.;

heating from −60° C. to +150° C. at a rate of +10° C./min. (first scan);

cooling from +150° C. to −60° C. at a rate of −5° C./min.;

heating from −60° C. to +150° C. at a rate of +10° C./min. (second scan);

operating under nitrogen flow (N₂) at 70 ml/min.

### Example 1 (Disclosure)

Copolymer Synthesis with Sulfur (50% by Weight) and Myrcene (50% by Weight) in the Presence of a Catalyst [zinc N-diethyldithiocarbamate (ZnDEC)—1% by Weight].

In a 40 ml vial, equipped with a magnetic stirrer, 2.5 g of pure sulfur [elemental sulfur in orthorhombic crystal form (S₈) from Sigma-Aldrich], 2.5 g of myrcene (Sigma-Aldrich) and 0.05 g of zinc N-diethyldithiocarbamate (ZnDEC) (Sigma-Aldrich) were loaded: the vial was closed with a cap and the whole was kept, under stirring, at 135° C., for 8 hours, obtaining a solid that could no longer be stirred. The solid obtained was slowly brought to room temperature) (25° and the copolymer obtained was submitted to DSC (Differential Scanning calorimetry) thermal analysis operating as above described, in order to measure the glass transition temperature (T_{g}) which was of 25° C.

### Example 2 (Comparative)

Copolymer Synthesis with Sulfur (50% by Weight) and Myrcene (50% by Weight) without a Catalyst

In a 40 ml vial, equipped with a magnetic stirrer, 2.5 g of pure sulfur [elemental sulfur in orthorhombic crystal form (S₈) from Sigma-Aldrich] and 2.5 g of myrcene (Sigma-Aldrich) were loaded: the vial was closed with a cap and the whole was kept, under stirring, at 135° C., for 24 hours, obtaining a fluid material that does not solidify: consequently, copolymerization did not occur and the copolymer was not obtained.

### Example 3 (Disclosure)

Copolymer Synthesis with Sulfur (50% by Weight) and 1,7-octadiene (50% by Weight) in the Presence of a Catalyst [Zinc N-diethyldithiocarbamate (ZnDEC)—1% by Weight]

In a 40 ml vial, equipped with a magnetic stirrer, 2.5 g of pure sulfur [elemental sulfur in orthorhombic crystal form (S₈) from Sigma-Aldrich], 2.5 g of 1,7-octadiene (Sigma-Aldrich) and 0.05 g of zinc N-diethyldithiocarbamate (ZnDEC) (Sigma-Aldrich) were loaded: the vial was closed with a cap and the whole was kept, under stirring, at 135° C., for 8 hours, obtaining a solid that could no longer be stirred. The solid obtained was slowly brought to room temperature) (25° and the copolymer obtained was submitted to DSC (Differential Scanning calorimetry) thermal analysis operating as above described, in order to measure the glass transition temperature (T_{g}) which was of −7° C.

### Example 4 (Comparative)

Copolymer Synthesis with Sulfur (50% by Weight) and 1,7-octadiene (50% by Weight) without a Catalyst

In a 40 ml vial, equipped with a magnetic stirrer, 2.5 g of pure sulfur [elemental sulfur in orthorhombic crystal form (S₈) from Sigma-Aldrich] and 2.5 g of 1,7-octadiene (Sigma-Aldrich) were loaded: the vial was closed with a cap and the whole was kept, under stirring, at 135° C., for 24 hours, obtaining a fluid material that does not solidify: consequently, copolymerization did not occur and the copolymer was not obtained.

### Example 5 (Disclosure)

Copolymer Synthesis with Sulfur (50% by Weight) and Limonene (50% by Weight) in the Presence of a Catalyst [Zinc N-diethyldithiocarbamate (ZnDEC)—5% by Weight].

In a 40 ml vial, equipped with a magnetic stirrer, 2.5 g of pure sulfur [elemental sulfur in orthorhombic crystal form (S₈) from Sigma-Aldrich], 2.5 g of limonene (Sigma-Aldrich) and 0.25 g of zinc N-diethyldithiocarbamate (ZnDEC) (Sigma-Aldrich) were loaded: the vial was closed with a cap and the whole was kept, under stirring, at 135° C., for 1 hour, obtaining a solid that could no longer be stirred. The solid obtained was slowly brought to room temperature) (25° and the copolymer obtained was submitted to DSC (Differential Scanning calorimetry) thermal analysis operating as above described, in order to measure the glass transition temperature (T_{g}) which was of 1° C.

### Example 6 (Comparative)

Copolymer Synthesis with Sulfur (50% by Weight) and Limonene (50% by Weight) without a Catalyst

In a 40 ml vial, equipped with a magnetic stirrer, 2.5 g of pure sulfur [elemental sulfur in orthorhombic crystal form (S₈) from Sigma-Aldrich] and 2.5 g of limonene (Sigma-Aldrich) were loaded: the vial was closed with a cap and the whole was kept, under stirring, at 135° C., for 12 hours, obtaining a viscous and sticky material that does not solidify: consequently, copolymerization did not occur and the copolymer was not obtained.

### Example 7 (Disclosure)

Copolymer Synthesis with Sulfur (50% by Weight) and Grapeseed Oil (50% by Weight) in the Presence of a Catalyst [Zinc Salt of 2-mercaptobenzothiazole (ZnMBT)—5% by Weight].

In a 40 ml vial, equipped with a magnetic stirrer, 2.5 g of pure sulfur [elemental sulfur in orthorhombic crystal form (S₈) from Sigma-Aldrich], 2.5 g of grapeseed oil (Sigma-Aldrich) and 0.25 g of zinc salt of 2-mercaptobenzothiazole (ZnMBT) (Sigma-Aldrich) were loaded: the vial was closed with a cap and the whole was kept, under stirring, at 135° C., for 2 hours, obtaining a solid that could no longer be stirred. The solid obtained was slowly brought to room temperature (25°) and the copolymer obtained was submitted to DSC (Differential Scanning calorimetry) thermal analysis operating as above described, in order to measure the glass transition temperature (T_{g}) which was of −32° C.

### Example 8 (Comparative)

Copolymer Synthesis with Sulfur (50% by Weight) and Grapeseed Oil (50% by Weight) without a Catalyst

In a 40 ml vial, equipped with a magnetic stirrer, 2.5 g of pure sulfur [elemental sulfur in orthorhombic crystal form (S₈) from Sigma-Aldrich] and 2.5 g of grapeseed oil (Sigma-Aldrich) were loaded: the vial was closed with a cap and the whole was kept, under stirring, at 135° C., for 8 hours, obtaining a fluid material that does not solidify: consequently, copolymerization did not occur and the copolymer was not obtained.

### Example 9 (Disclosure)

### Copolymer Synthesis with Sulfur (50% by Weight) and Grapeseed Oil (50% by Weight) in the Presence of a Catalyst [Zinc Salt of Iso-Propylxantate (ZnIX)—5% by Weight]

In a 40 ml vial, equipped with a magnetic stirrer, 2.5 g of pure sulfur [elemental sulfur in orthorhombic crystal form (S₈) from Sigma-Aldrich], 2.5 g of grapeseed oil (Sigma-Aldrich) and 0.25 g of zinc salt of iso-propylxantate (ZnIX) (Alfa Chemistry) were loaded: the vial was closed with a cap and the whole was kept, under stirring, at 135° C., for 5 hours, obtaining a solid that could no longer be stirred. The solid obtained was slowly brought to room temperature) (25° and the copolymer obtained was submitted to DSC (Differential Scanning calorimetry) thermal analysis operating as above described, in order to measure the glass transition temperature (T_{g}) which was lower than −30° C.

### Example 10 (Comparative)

Copolymer Synthesis with Sulfur (50% by Weight) and Grapeseed Oil (50% by Weight) without a Catalyst

In a 40 ml vial, equipped with a magnetic stirrer, 2.5 g of pure sulfur [elemental sulfur in orthorhombic crystal form (S₈) from Sigma-Aldrich] and 2.5 g of grapeseed oil (Sigma-Aldrich) were loaded: the vial was closed with a cap and the whole was kept, under stirring, at 135° C., for 8 hours, obtaining a fluid material that does not solidify: consequently, copolymerization did not occur and the copolymer was not obtained.

### Example 11 (Disclosure)

Copolymer Synthesis with Sulfur (70% by Weight) and Grapeseed Oil (30% by Weight) in the Presence of a Catalyst [Zinc Salt of 2-mercaptobenzothiazole (ZnMBT)—1% by Weight].

In a 40 ml vial, equipped with a magnetic stirrer, 3.5 g of pure sulfur [elemental sulfur in orthorhombic crystal form (S₈) from Sigma-Aldrich], 1.5 g of grapeseed oil (Sigma-Aldrich) and 0.05 g of zinc salt of 2-mercaptobenzothiazole (ZnMBT) (Sigma-Aldrich) were loaded: the vial was closed with a cap and the whole was kept, under stirring, at 135° C., for 5 hours, obtaining a solid that could no longer be stirred. The solid obtained was slowly brought to room temperature (25°) and the copolymer obtained was submitted to DSC (Differential Scanning calorimetry) thermal analysis operating as above described, in order to measure the glass transition temperature (T_{g}) which was lower than −30° C.

### Example 12 (Disclosure)

Copolymer Synthesis with Sulfur (70% by Weight) and 1,3-di-iso-propenylbenzene (30% by Weight) in the Presence of a Catalyst [Zinc N-diethyl dithiocarbamate (ZnDEC)—1% by Weight]

In a 40 ml vial, equipped with a magnetic stirrer, 3.5 g of pure sulfur [elemental sulfur in orthorhombic crystal form (S₈) from Sigma-Aldrich], 1.5 g of 1,3-di-iso-propenylbenzene (Sigma-Aldrich) and 0.05 g of zinc N-diethyl dithiocarbamate (ZnDEC) (Sigma-Aldrich) were loaded: the vial was closed with a cap and the whole was kept, under stirring, at 135° C., for 40 minutes, obtaining a solid that could no longer be stirred. The solid obtained was slowly brought to room temperature (25° C.) and the copolymer obtained was submitted to DSC (Differential Scanning calorimetry) thermal analysis operating as above described, in order to measure the glass transition temperature (T_{g}) which was of about 20° C.

1. Process for high sulfur content copolymer preparation comprising reacting sulfur in solid form with at least one crosslinker selected from organic compounds including at least a double or triple bond in the presence of at least one catalyst selected from the group consisting of dithiocarbamates, mercaptobenzothiazoles, xanthates, and thiophosphates, at a temperature ranging from 110° C. to 180° C.

2. Process for high sulfur content copolymer preparation according to claim 1, wherein said sulfur in solid form is elemental sulfur.

3. Process for high sulfur content copolymer preparation according to claim 1, wherein said crosslinker selected from organic compounds including at least a double or triple bond is selected from the group consisting of
ethylenically unsaturated monomers selected from the group consisting of linear aliphatic α-olefins; alicyclic olefins and diolefins; conjugated polyenes; bicycle olefins; and aromatic vinyl compounds;
alkynic monomers;
natural oils; and
mixtures thereof.

4. Process for high sulfur content copolymer preparation according to claim 3, wherein said crosslinker selected from organic compounds including at least a double or triple bond selected from the group consisting of myrcene, 1,7-octadiene, grapeseed oil, and 3-di-iso-propenylbenzene (DIB).

5. Process for high sulfur content copolymer preparation according to claim 1, wherein said dithiocarbamates are selected from the group consisting of zinc N-dimethyldithiocarbamate (ZnDEC), zinc N-diethyldithiocarbamate (ZnDEC), zinc N-dibutyldithiocarbamate (ZnDBC), zinc N-ethylphenyl dithiocarbamate (ZnEPC), zinc N-pentamethylenedithiocarbamate (ZnCMC), zinc N-dibenzyldithiocarbamate (ZnBEC), copper N-diethyl-dithiocarbamate (CuDEC), sodium N-diethyldithiocarbamate (NaDMC), cobalt N-diethyldithiocarbamate (CoDMC), and mixtures thereof.

6. Process for high sulfur content copolymer preparation according to claim 1, wherein said mercaptobenzothiazoles are selected from the group consisting of 2-mercaptobenzothiazole (MBT), zinc salt of 2-mercaptobenzothiazole (ZnMBT), copper salt of 2-mercaptobenzothiazole (CuMBT), cobalt salt of 2-mercaptobenzothiazole (CoMBT), sodium salt of 2-mercaptobenzothiazole (NaMBT), and mixtures thereof.

7. Process for high sulfur content copolymer preparation according to claim 1, wherein said xanthates are selected from the group consisting of zinc iso-propylxantate (ZnIX), zinc butylxantate (ZnBX), sodium iso-propylxantate (NaIX), copper iso-propylxantate (CuIX), cobalt iso-propylxantate (CoIX), and mixtures thereof.

8. Process for high sulfur content copolymer preparation according to claim 1, wherein said thiophosphates are selected from the group consisting of zinc O,O-di-n-butyl dithiophosphate (ZBDP), zinc O-butyl-O-hexyl dithiophosphate, zinc O,O-di-iso-octyl dithiophosphate, cobalt O,O-di-n-butyl dithiophosphate (CoBDP), copper O,O-di-n-butyl dithiophosphate (CuBDP), and mixtures thereof.

9. Process for high sulfur content copolymer preparation according to claim 1, wherein said catalyst is used in a quantity ranging from 0.5% by weight to 10% by weight with respect to the total weight of the sulfur in solid form and of said at least one crosslinker selected from organic compounds including at least a double or triple bond.

10. Process for high sulfur content copolymer preparation according to claim 1, wherein said copolymer with a high sulfur content comprises sulfur in quantity greater than or equal to 35% by weight with respect to the total weight of said copolymer and at least one organic compound including at least a double or triple bond in a quantity lower than or equal to 65% by weight with respect to the total weight of said copolymer.

11. A method, comprising incorporating an elastomeric high sulfur content copolymer obtained in accordance with the process according to claim 1 in an application selected from the group consisting of thermal insulation, conveyor belts, transmission belts, flexible tubes, and elastomeric tire compositions.

12. A method, comprising incorporating a thermoplastic high sulfur content copolymer obtained in accordance with the process according to claim 1, alone or in admixture with other polymers in applications selected from the group consisting of packaging, electronics, household appliances, computer cases, CD cases, office and medical items, and building and construction materials.

13. Process for high sulfur content copolymer preparation according to claim 1, wherein the temperature ranges from 120° C. to 150° C.

14. Process for high sulfur content copolymer preparation according to claim 1, wherein the time ranges from 20 minutes to 12 hours.

15. Process for high sulfur content copolymer preparation according to claim 1, wherein the time ranges from 30 minutes to 10 hours.

16. Process for high sulfur content copolymer preparation according to claim 1, wherein the linear aliphatic α-olefins are selected from the group consisting of 1,7-octadiene 1-dodecene, 5-methyl-1-heptene, 2,5-dimethyl-1,5-hexadiene, and mixtures thereof; wherein the alicyclic olefins and diolefins are selected from the group consisting of d-limonene, 1,4-dimethylenecyclohexane, 1-methylene-4-vinylcyclohexane, and mixtures thereof; wherein the conjugated polyenes are selected from the group consisting of 2-phenyl-1,3-butadiene, myrcene, allocymene, 1-vinylcyclohexene, ethylbenzofulvene, and mixtures thereof; wherein the bicycle olefins are selected from the group consisting of α-pinene, β-pinene, 2-methylene-norbornene, and mixtures thereof; wherein the aromatic vinyl compounds are selected from the group consisting of styrene, divinyl benzene, vinyl toluene, Cert-butyl styrene, p-methyl styrene, γ-methyl styrene, α-methyl styrene, vinyl naphthalene, 1,3-di-iso-propenylbenzene (DIB) and mixtures thereof; wherein alkynic monomers are selected from the group consisting of 1,3-diethynylbenzene (DEB), 2-ethynyl-1,3-dimethylbenzene, 1,3,5-triethynylbenzene; and mixtures thereof; and wherein natural oils are selected from the group consisting of grapeseed oil, castor oil, soybean oil, linseed oil, sesame oil, and mixtures thereof.

17. Process for high sulfur content copolymer preparation according to claim 1, wherein the xanthates are zinc iso-propylxantate (ZnIX).

18. Process for high sulfur content copolymer preparation according to 1, wherein said dithiocarbamates are zinc N-diethyldithiocarbamate (ZnDEC).

19. Process for high sulfur content copolymer preparation according to claim 1, wherein the mercaptobenzothiazoles are zinc salt of 2-mercaptobenzothiazole (ZnMBT).

20. Process for high sulfur content copolymer preparation according to claim 1, wherein the xanthates are zinc iso-propylxantate (ZnIX).
